(19) United States
(12) Patent Application Publication
(10) Pub. No.: US 2024/0291178 A1
(43) Pub. Date: Aug. 29, 2024

(54) CONTACT, CONNECTOR AND CABLE ASSEMBLY

(71) Applicant: JAPAN AVIATION ELECTRONICS INDUSTRY, LIMITED, Shibuya-ku, Tokyo (JP)

(72) Inventors: Yuki SUDA, Tokyo (JP); Chikara KAWAMURA, Tokyo (JP)

(73) Assignee: JAPAN AVIATION ELECTRONICS INDUSTRY, LIMITED, Shibuya-ku, Tokyo (JP)

(21) Appl. No.: 18/571,764

(22) PCT Filed: May 27, 2022
(86) PCT No.: PCT/JP2022/021667

§ 371 Date: Dec. 19, 2023

(30) Foreign Application Priority Data
Jul. 20, 2021 (JP) 2021-119229

(51) Int. Cl. H01R 9/05; H01R 11/28

(52) U.S. Cl. CPC H01R 9/0518; H01R 11/28

(57) ABSTRACT

A contact is connected to a front end in the longitudinal direction (X direction) of a cable provided with an outer conductor at the outer periphery thereof. The contact has a pressure bonding part and an acceptance part. The pressure bonding part is pressure-bonded to the outer conductor so as to surround the outer conductor in a connection state in which the contact is connected to the cable. The acceptance part is located in front of the pressure bonding part, and partially accepts the outer conductor in the connection state. The acceptance part has at least two parts to be pressed. Each of the parts to be pressed is located outside the outer conductor on an orthogonal plane (Y-Z plane) and pressed against the outer conductor in a connection state.

### TECHNICAL FIELD

This invention relates to a contact configured to be connected to a cable which is provided with an outer conductor.

### BACKGROUND ART

For example, this type of contact is disclosed in Patent Document 1.

Referring to FIG. 15, Patent Document 1 discloses an electric contact means (contact) 90 configured to be connected to a cable 96 which is provided with an outer conductor 98. The contact 90 has a crimp portion 92. The crimp portion 92 is configured to be crimped on the outer conductor 98 so that it surrounds the outer conductor 98, and thereby the contact 90 is electrically connected with the outer conductor 98.

### PRIOR ART DOCUMENTS

### Patent Document(s)

Patent Document 1: JPA 2017-168440

### SUMMARY OF INVENTION

### Technical Problem

According to an existing contact such as that of Patent Document 1, anti-noise performance of the contact might vary when the contact is crimped on an outer conductor.

It is therefore an object of the present invention to provide a contact which has stable anti-noise performance.

### Solution to Problem

An aspect of the present invention provides a contact configured to be connected to a front end portion of a cable in a front-rear direction, the cable having an outer conductor provided on an outer circumference thereof. The contact has a crimp portion and a receiving portion. The crimp portion is crimped on the outer conductor so that it surrounds the outer conductor under a connected state where the contact is connected to the cable. The receiving portion is located forward of the crimp portion and partially receives the outer conductor under the connected state. The receiving portion has two or more pressed portions. Each of the pressed portions is located outward of the outer conductor in a perpendicular plane perpendicular to the front-rear direction and is pressed against the outer conductor under the connected state.

### Advantageous Effects of Invention

When a crimp portion of a contact such as that of Patent Document 1 or the present invention is crimped on an outer conductor of a cable, a part located forward of the crimp portion is formed with a gap. When the gap is formed, electromagnetic shielding performance, or anti-noise performance, of the contact might be degraded. However, the contact of the present invention has the receiving portion which is located forward of the crimp portion. The receiving portion has the two or more pressed portions. Each of the pressed portions is pressed against the outer conductor, reliably brought into contact with the outer conductor and prevents degradation of the anti-noise performance of the contact. Thus, the present invention provides a contact which has stable anti-noise performance.

An appreciation of the objectives of the present invention and a more complete understanding of its structure may be had by studying the following description of the preferred embodiment and by referring to the accompanying drawings.

### BRIEF DESCRIPTION OF DRAWINGS

FIG. 1 is a perspective view showing a cable assembly according to an embodiment of the present invention, wherein an imaginary axis of a contact is illustrated with dashed line.

FIG. 2 is an exploded, perspective view showing the cable assembly of FIG. 1.

FIG. 3 is a perspective view showing the contact of the cable assembly of FIG. 1, wherein a crimp portion of the contact is opened, and the imaginary axis is illustrated with dashed line.

FIG. 4 is another perspective view showing the contact of FIG. 3, wherein the crimp portion of the contact is closed, and the imaginary axis is illustrated with dashed line.

FIG. 5 is a perspective view showing a receiving portion of the contact of FIG. 4, wherein a position of a front end of a pressed portion is illustrated with dashed line, and the imaginary axis is illustrated with chain dotted line.

FIG. 6 is a top view showing the cable assembly of FIG. 1.

FIG. 7 is a cross-sectional view showing the cable assembly of FIG. 6, taken along line VII-VII, wherein a part of the cable assembly enclosed by dashed line is enlarged and illustrated.

FIG. 8 is a top view showing a first modification of the cable assembly of FIG. 6.

FIG. 9 is a perspective view showing a receiving portion of a contact of the cable assembly of FIG. 8, wherein the imaginary axis is illustrated with dashed line.

FIG. 10 is a top view showing a second modification of the cable assembly of FIG. 6.

FIG. 11 is a cross-sectional view partially showing the cable assembly of FIG. 10, taken along line XI-XI, wherein the illustrated cross-section corresponds to the enlarged view of FIG. 7.

FIG. 12 is a top view showing a contact of the cable assembly of FIG. 10, wherein a crimp portion of the contact is closed.

FIG. 13 is a cross-sectional view partially showing the contact of FIG. 12, taken along line XIII-XIII.

FIG. 14 is a perspective view showing a receiving portion of the contact of FIG. 12.

FIG. 15 is a perspective view showing a contact of Patent Document 1 together with a cable.

### DESCRIPTION OF EMBODIMENTS

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

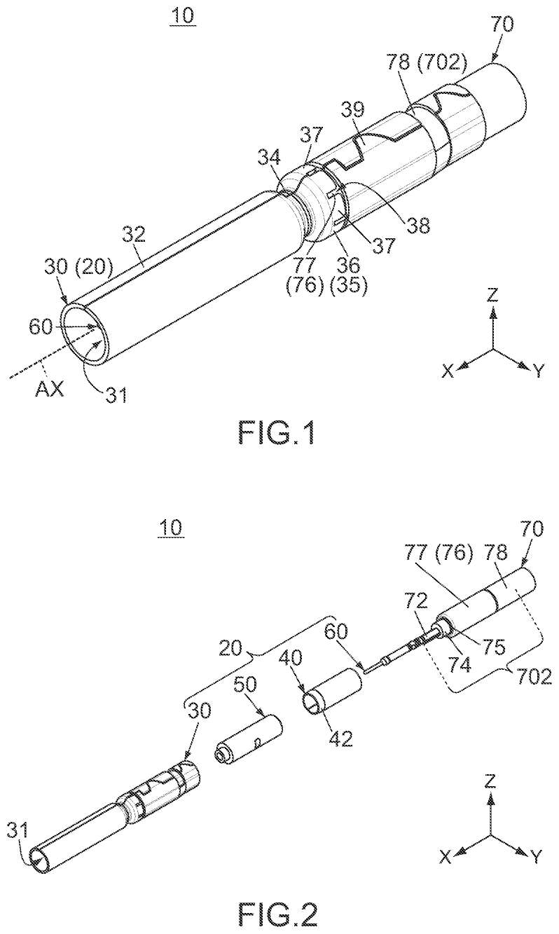

Referring to FIGS. 1 and 2, a cable assembly 10 according to an embodiment of the present invention comprises a connector 20 and a cable 70. The cable 70 has a front end portion 702. The front end portion 702 is located at a front end of the cable 70 in a front-rear direction and is attached to a rear end of the connector 20. The front-rear direction of the present embodiment is the X-direction. “Forward” means the positive X-direction, and “rearward” means the negative X-direction.

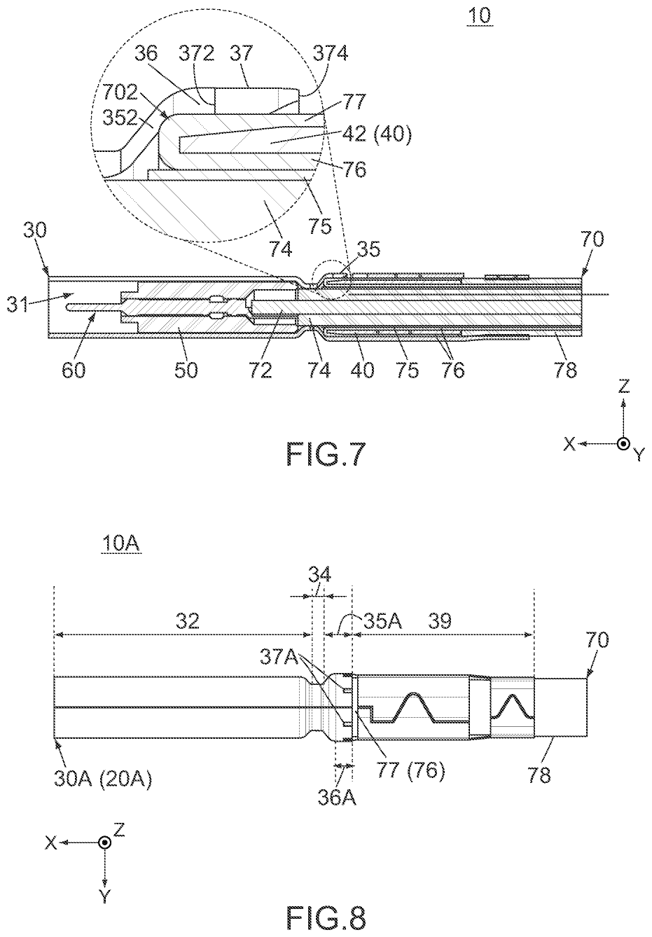

Referring to FIGS. 2 and 7, the cable 70 of the present embodiment comprises one inner conductor 72 made of conductor, an inner dielectric 74 made of insulator, a conductive coat 75 made of conductor, an outer conductor 76 made of conductor and a sheath 78 made of insulator. The inner dielectric 74 covers the inner conductor 72 in a perpendicular plane (YZ-plane) perpendicular to the front-rear direction. The conductive coat 75 covers the inner dielectric 74 in the YZ-plane. The outer conductor 76 covers the conductive coat 75 in the YZ-plane. The sheath 78 covers the outer conductor 76 in the YZ-plane.

The cable 70 of the present embodiment is a coaxial cable which has the aforementioned structure. The cable 70 has a circular shape in the YZ-plane. However, the present invention is not limited thereto. For example, the cable 70 may comprise two of the inner conductors 72. The two inner conductors 72 may form a differential pair. The cable 70 may comprise three or more of the inner conductors 72. The shape of the cable 70 in the YZ-plane may be an ellipse shape, for example.

The cable 70 of the present embodiment has the inner conductor 72 which is located at the center thereof in the YZ-plane and the outer conductor 76 which is located outward of the inner conductor 72 in the YZ-plane. The inner conductor 72 is a conductive body for transmitting signals. The conductive coat 75 is made of aluminum mylar. The outer conductor 76 is a braid formed of fine metal wires. The conductive coat 75 and the outer conductor 76 cover and electromagnetically shield the inner conductor 72. The cable 70 of the present embodiment has the aforementioned shield structure. However, the shield structure of the cable 70 is not specifically limited, provided that the cable 70 has the outer conductor 76. For example, the conductive coat 75 may be provided as necessary. The outer conductor 76 may be formed of metal foil.

As can be seen from FIGS. 2 and 7, the front end portion 702 of the cable 70 is processed when the cable assembly 10 is assembled. In detail, a front end of the sheath 78 is removed, and thereby the outer conductor 76 is partially exposed from the sheath 78. Thus, the cable 70 has the outer conductor 76 provided on an outer circumference thereof in the YZ-plane. Moreover, a front end of the inner dielectric 74 is removed, and thereby the inner conductor 72 is partially exposed from the inner dielectric 74.

Referring to FIG. 2, the connector 20 of the present embodiment comprises a contact 30 made of conductor, a conductive member 40 made of conductor, a dielectric member 50 made of insulator and an inner contact 60 made of conductor. Each of the contact 30, the conductive member 40 and the dielectric member 50 of the present embodiment has a hollow cylindrical shape. The inner contact 60 of the present embodiment is a metal pin.

The connector 20 of the present embodiment comprises the aforementioned members. However, the present invention is not limited thereto. The dielectric member 50 and the inner contact 60 may be provided as necessary, provided that the connector 20 comprises the contact 30 and the conductive member 40. Instead, the connector 20 may further comprise another member in addition to the aforementioned members. For example, the connector 20 may further comprise an insulative housing which holds the conductive member 40. The structure of each of the dielectric member 50 and the inner contact 60 is not specifically limited. For example, the inner contact 60 may be a socket.

The cable assembly 10 of the present embodiment is assembled as described below.

Referring to FIGS. 2 and 7, first, the cable 70 is processed as previously described. Then, the inner contact 60 is fixed to a front end of the exposed inner conductor 72 of the cable 70. The thus-fixed inner contact 60 is electrically connected with the inner conductor 72 and extends forward from the front end the inner conductor 72.

Then, the conductive member 40 is attached to the cable 70 so that the exposed outer conductor 76 of the cable 70 is covered thereby in the YZ-plane. When the conductive member 40 is attached to the cable 70, a front part of the outer conductor 76 is exposed from the conductive member 40 and extends forward. Then, the front part of the outer conductor 76 is folded rearward so that a folded portion 77 is formed. The folded portion 77 is a part of the outer conductor 76 which is folded rearward. The outer conductor 76 including the folded portion 77 is located on an outer circumference of the cable 70 in the YZ-plane. The folded portion 77 covers the conductive member 40 in the YZ-plane.

Then, the dielectric member 50 is inserted into the contact 30 from front and is attached to the contact 30. Then, the contact 30 is connected to the cable 70 so that the contact 30 covers the folded portion 77 in the YZ-plane. The thus-connected contact 30 is electrically connected with the outer conductor 76. Moreover, when the contact 30 is connected to the cable 70, the dielectric member 50 is attached to the inner contact 60 so that the dielectric member 50 wholly covers the inner contact 60 in the YZ-plane. The thus-attached dielectric member 50 insulates the inner contact 60.

The cable assembly 10 which is assembled as described above comprises the contact 30 and the cable 70. The contact 30 is connected to the front end portion 702 of the cable 70. According to the present embodiment, the outer conductor 76 is formed with the folded portion 77. The contact 30 is connected to the folded portion 77 of the outer conductor 76. However, the present invention is not limited thereto. For example, the folded portion 77 may be formed as necessary. In an instance where the folded portion 77 is not formed, the conductive member 40 may be inserted between the outer conductor 76 and the inner dielectric 74. In another instance where the folded portion 77 is not formed, the conductive member 40 does not need to be provided. In an instance where the folded portion 77 is not formed, the contact 30 may be connected to the outer conductor 76 which is not folded.

When the cable assembly 10 is assembled as described above, the front end portion 702 which is one of end portions of the cable 70 is connected to the connector 20. The opposite end portion (not shown) of the cable 70 is connected to an electronic device (not shown). Under a mated state where the connector 20 is mated with a mating connector (not shown), the electronic device is electrically connected with a mating electronic device (not shown) which is provided with the mating connector. In detail, under the mated state, the inner contact 60 is connected to a mating signal contact (not shown) of the mating connector and transmits high-frequency signals, for example. Under the mated state, the contact 30 and the conductive member 40 have ground potentials and reduce noise due to high-frequency signals.

Hereafter, explanation will be made about the contact 30 of the present embodiment.

Referring to FIGS. 1 and 6, the contact 30 is configured to be connected to the front end portion 702 of the cable 70 in the front-rear direction, the cable 70 having the outer conductor 76 provided on the outer circumference thereof.

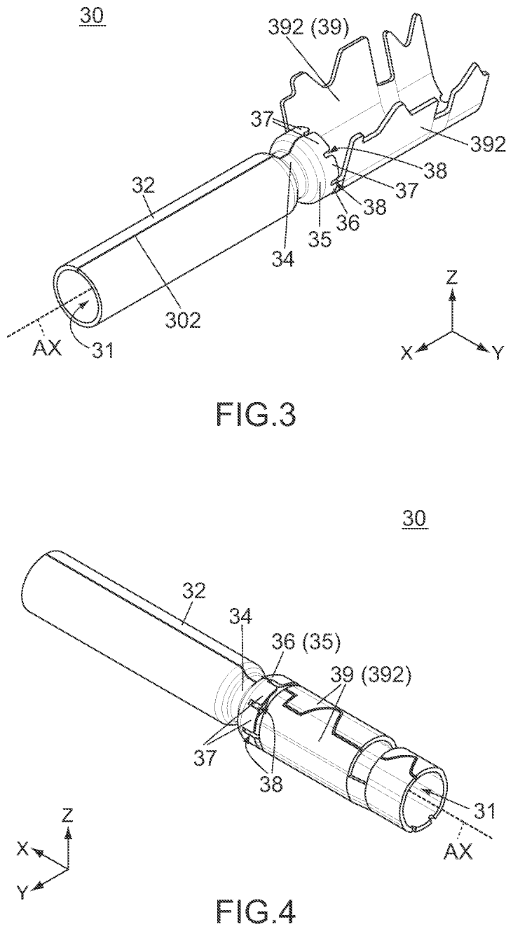

Referring to FIG. 3, the contact 30 extends along the front-rear direction. The contact 30 of the present embodiment is formed by bending a single metal plate about an imaginary axis AX extending in parallel to the front-rear direction. In other words, the contact 30 is a single metal plate with bends. The contact 30 is formed with a slit 302 which extends along the front-rear direction. The slit 302 is a narrow space. The slit 302 is located between opposite edges of the bent metal plate in a lateral direction perpendicular to the front-rear direction. The slit 302 is located at an upper end of the contact 30 in an upper-lower direction perpendicular to both the front-rear direction and the lateral direction. The lateral direction of the present embodiment is the Y-direction. The upper-lower direction of the present embodiment is the Z-direction. “Upward” means the positive Z-direction, and “downward” means the negative Z-direction.

Referring to FIGS. 1, 3 and 4, the contact 30 is formed with a passing hole 31. The passing hole 31 extends along the imaginary axis AX and passes through the contact 30 in the front-rear direction. Referring to FIG. 7, in the assembled cable assembly 10, the dielectric member 50 and the inner contact 60 are accommodated in the passing hole 31. The passing hole 31 of the present embodiment has a circular shape in the YZ-plane. However, the present invention is not limited thereto, but the shape of the passing hole 31 can be modified as necessary.

As shown in FIGS. 3, 4 and 6, the contact 30 of the present embodiment has a connection portion 32, a narrow portion 34, a receiving portion 35 and a crimp portion 39. The connection portion 32 is a front part of the contact 30. The crimp portion 39 is a rear part of the contact 30. The receiving portion 35 is located forward of the crimp portion 39. The narrow portion 34 is located between the connection portion 32 and the receiving portion 35 in the front-rear direction. In other words, the narrow portion 34 is located forward of the receiving portion 35. The contact 30 of the present embodiment has the aforementioned structure. However, the present invention is not limited thereto, but the structure of the contact 30 can be modified as necessary. For example, the contact 30 may further have another portion in addition to the aforementioned portions.

The connection portion 32 of the present embodiment extends along the front-rear direction. The connection portion 32 is connected to a mating conductive member (not shown) of the mating connector (not shown) under the mated state. The connection portion 32 of the present embodiment has a circular shape in the YZ-plane. However, the present invention is not limited thereto, but the shape of the connection portion 32 can be modified as necessary. For example, the connection portion 32 may have a rectangular shape in the YZ-plane.

Referring to FIG. 3, the crimp portion 39 of the present embodiment has an open barrel shape. In detail, the crimp portion 39 has two crimp pieces 392. The crimp pieces 392 are apart from each other before the contact 30 is connected to the cable 70 (see FIG. 6). In other words, the crimp portion 39 is opened before the contact 30 is connected to the cable 70.

Referring to FIG. 6 together with FIG. 4, as described later, when the contact 30 is connected to the cable 70 in a process in which the cable assembly 10 is assembled, the front end portion 702 of the cable 70 is inserted into the contact 30 from behind. Then, the crimp portion 39 is crimped around the cable 70. In detail, the two crimp pieces 392 are combined together so that they are wound around the outer conductor 76 and the sheath 78 of the front end portion 702. In other words, the crimp portion 39 is crimped on the outer conductor 76 so that it surrounds the outer conductor 76 under a connected state, or a state shown in FIG. 6, where the contact 30 is connected to the cable 70. Thus, the crimp portion 39 is closed under the connected state, and thereby the contact 30 is securely fixed to the cable 70.

The crimp portion 39 of the present embodiment is crimped around the folded portion 77 of the cable 70. The folded portion 77 covers the conductive member 40. The conductive member 40 of the present embodiment is made of metal and has rigidity. The conductive member 40 prevents the cable 70 from being deformed when the crimp portion 39 is crimped, and thereby the crimp portion 39 is securely crimped around the folded portion 77. However, the present invention is not limited thereto, but the conductive member 40 may be provided as necessary.

The crimp portion 39 of the present embodiment encloses the outer conductor 76 with no gap under the connected state except for a slight space formed between the two crimp pieces 392. However, the present invention is not limited thereto. For example, the structure of the crimp portion 39 can be modified as necessary.

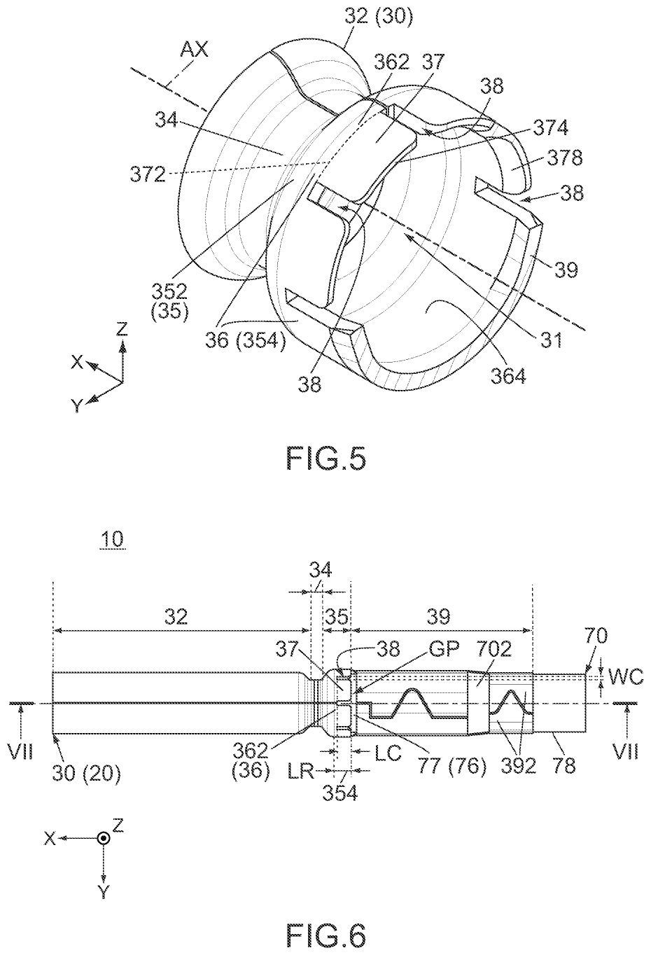

Referring to FIG. 5, the receiving portion 35 of the present embodiment has a front portion 352 and a rear portion 354. The front portion 352 is a front part of the receiving portion 35. The front portion 352 is gradually narrowed forward. In detail, a size of the front portion 352 in the YZ-plane becomes gradually smaller forward. The rear portion 354 is a rear part of the receiving portion 35. The rear portion 354 has a cylindrical shape as a whole. In detail, the rear portion 354 has a constant size in the YZ-plane regardless of a position thereof in the front-rear direction. The receiving portion 35 of the present embodiment has the aforementioned structure. However, the present invention is not limited thereto. For example, the receiving portion 35 may have only the rear portion 354.

The receiving portion 35 of the present embodiment has a body 36 and four pressed portions (spring pieces) 37. Each of the body 36 and the pressed portions 37 is a part of the rear portion 354. The body 36 has a ring-like portion 362. The ring-like portion 362 has a circular shape in the YZ-plane. The body 36 has a remaining portion which extends rearward from a lower part of the ring-like portion 362. The pressed portions 37 extend rearward from an upper part of the ring-like portion 362. The rear portion 354 of the present embodiment has the aforementioned structure. However, the present invention is not limited thereto. For example, the ring-like portion 362 may be provided as necessary.

The body 36 has an inner surface 364. The inner surface 364 is an inside surface of the body 36 in the YZ-plane and faces the passing hole 31. The inner surface 364 of the body 36 extends along the front-rear direction in an imaginary cylindrical surface around the imaginary axis AX. Each of the pressed portions 37 extends along the front-rear direction and has a front end 372 and a rear end 374. Each of the front ends 372 is connected to a rear edge of the ring-like portion 362 of the body 36. Each of the pressed portions 37 has a sloping surface 378. Each of the sloping surfaces 378 faces the passing hole 31. Each of the pressed portions 37 has a part which is located in the vicinity of the rear end 374 and is inclined outward in the YZ-plane. As can be seen from the explanation described above, the passing hole 31 of the receiving portion 35 of the present embodiment is widened rearward as a whole.

The body 36 of the present embodiment is formed with five cut 38. Each of the cuts 38 extends along the front-rear direction and passes through the body 36 in the radial direction about the imaginary axis AX. Each of the pressed portions 37 of the present embodiment is a spring piece 37. Each of the pressed portions 37 is located between two of the cuts 38 adjacent to each other in a circumferential direction about the imaginary axis AX. Each of the pressed portions (spring pieces) 37 extends along the front-rear direction and is resiliently deformable with the rear end 374 which is a free end.

Referring to FIG. 7, the front end portion 702 of the cable 70 is inserted into the passing hole 31 of the contact 30 from behind before the crimp portion 39 is crimped around the cable 70 in a process in which the contact 30 is connected to the cable 70. Hereafter, explanation will be made about the contact 30 and the conductive member 40, and explanation will be made about an insertion process of the front end portion 702.

Referring to FIG. 5 together with FIG. 2, in the explanation described below, a cross-section of the passing hole 31 in the YZ-plane is referred to as “hole cross-section”, and a cross-section of the cable 70 in the YZ-plane is referred to as “cable cross-section”. The hole cross-section at the rear end 374 of the sloping surface 378 of the receiving portion 35 is larger than the cable cross-section in the vicinity of a front end of the outer conductor 76 of the cable 70. However, the hole cross-section at the front end 372 of the sloping surface 378 is smaller than the cable cross-section in the vicinity of the front end of the outer conductor 76 of the cable 70.

The narrow portion 34 of the present embodiment has a size in the YZ-plane which is smaller than another size of the receiving portion 35 in the YZ-plane. In detail, the hole cross-section at the narrow portion 34 is smaller than the hole cross-section at the front end 372 of the sloping surface 378. Thus, the hole cross-section at the narrow portion 34 is smaller than the cable cross-section in the vicinity of the front end of the outer conductor 76 of the cable 70. However, the hole cross-section at the narrow portion 34 is larger than the cable cross-section of the inner dielectric 74 of the cable 70.

According to the aforementioned structure, the outer conductor 76 of the front end portion 702 is insertable into the receiving portion 35 but is not insertable into the narrow portion 34. However, the inner dielectric 74 and the inner conductor 72 of the front end portion 702 are insertable into the passing hole 31 of the connection portion 32 through the narrow portion 34 together with the inner contact 60. Thus, the narrow portion 34 of the present embodiment defines a front end of the receiving portion 35 in which the outer conductor 76 is receivable. However, the present invention is not limited thereto. For example, the narrow portion 34 may be provided as necessary.

In detail, when the front end portion 702 of the cable 70 is inserted into the passing hole 31 from behind, the outer conductor 76 of the front end portion 702 is guided by the sloping surfaces 378 of the pressed portions 37 of the receiving portion 35 and is received in a rear end portion of the receiving portion 35. When the front end portion 702 is continuously inserted, the outer conductor 76 is moved forward while resiliently deforming the pressed portions 37. Meanwhile, each of the pressed portions 37 is resiliently deformed while the rear end 374 is moved outward in the YZ-plane. When the front end portion 702 is continuously inserted, the front end of the outer conductor 76 is brought into abutment with an inner wall of the front portion 352 of the receiving portion 35, and the insertion of the front end portion 702 ends. At that time, the inner conductor 72 of the front end portion 702 has passed through the receiving portion 35 and is located in the connection portion 32.

As can be seen from the explanation described above, the receiving portion 35 partially receives the outer conductor 76 under the connected state. When the outer conductor 76 is received in the receiving portion 35, each of the resiliently deformed pressed portions 37 is pressed against the outer conductor 76 by a restoring force. According to the present embodiment, under the connected state, the front end of the outer conductor 76 is located forward of front ends of the cuts 38. According to this arrangement, the outer conductor 76 can be reliably connected to the receiving portion 35. However, the present invention is not limited thereto. For example, the front end of the outer conductor 76 may be located rearward of the front ends of the cuts 38 under the connected state.

Referring to FIGS. 5 and 7, according to the present embodiment, each of the pressed portions 37 is pressed against the outer conductor 76 while being resiliently deformed in a process in which the outer conductor 76 of the cable 70 is inserted into the receiving portion 35. However, the present invention is not limited thereto. For example, the hole cross-section at the front end 372 of the sloping surface 378 of the receiving portion 35 may be larger than the cable cross-section in the vicinity of the front end of the outer conductor 76. In this instance, each of the pressed portions 37 may be plastically deformed inward in the YZ-plane to be pressed against the outer conductor 76 after the outer conductor 76 is received in the receiving portion 35.

Referring to FIG. 3, according to the contact 30 such as that of the present embodiment, each of the crimp pieces 392 of the crimp portion 39 is apart from the receiving portion 35 and is located rearward of the receiving portion 35. Referring to FIG. 6, according to this structure, the crimp pieces 392 can be easily wound around the outer conductor 76 of the cable 70. However, when the crimp portion 39 is crimped on the outer conductor 76, a part located forward of the crimp portion 39 is inevitably formed with a gap GP. According to the present embodiment, the gap GP is formed between the crimp pieces 392 and the receiving portion 35. When the gap GP is formed, electromagnetic shielding performance, or anti-noise performance, of the contact 30 might be degraded.

However, the contact 30 of the present embodiment has the receiving portion 35 which is located forward of the crimp portion 39. The receiving portion 35 has two or more of the pressed portions 37. Each of the pressed portions 37 is pressed against the outer conductor 76 to be reliably brought into abutment with the outer conductor 76 and prevent degradation of the anti-noise performance of the contact 30. Thus, the present embodiment provides the contact 30 which has stable anti-noise performance.

Referring to FIGS. 2 and 7, the conductive member 40 of the present embodiment has a received portion 42. The received portion 42 is located at a front end of the conductive member 40. The received portion 42 is narrowed forward. In detail, a size of the received portion 42 in the YZ-plane becomes gradually smaller forward. As previously described, according to the present embodiment, when the cable assembly 10 is assembled, the outer conductor 76 is formed with the folded portion 77 which is folded rearward, and the conductive member 40 is located inward of the folded portion 77 in the YZ-plane.

The outer conductor 76 of the cable 70 is inserted into the receiving portion 35 together with the conductive member 40 having the received portion 42. According to the present embodiment, the outer conductor 76 can be smoothly inserted into the receiving portion 35 because the conductive member 40 having the tapered received portion 42 is provided. However, the present invention is not limited thereto, but the structure of the conductive member 40 can be modified as necessary.

As described above, under the connected state according to the present embodiment, the outer conductor 76 is formed with the folded portion 77 which is folded rearward, the conductive member 40 is located inward of the folded portion 77 in the YZ-plane, the folded portion 77 is sandwiched between the crimp portion 39 and the conductive member 40, and the received portion 42 of the conductive member 40 is received in the receiving portion 35 of the contact 30 together with the folded portion 77.

Referring to FIG. 5 together with FIG. 7, the pressed portions 37 of the present embodiment have shapes same as each other. Moreover, the pressed portions 37 are arranged in the circumferential direction about the imaginary axis AX with regular intervals. However, the present invention is not limited thereto. For example, the pressed portions 37 may have shapes different from each other. Only two of the pressed portions 37 may be formed. These two pressed portions 37 may extend rearward from the vicinity of an upper end of the ring-like portion 362. Instead, a large number of the pressed portions 37 may be formed over whole of the ring-like portion 362 in the circumferential direction. The contact 30 is more reliably brought into contact with the outer conductor 76 of the cable 70 by increasing the number of the pressed portions 37.

Referring to FIG. 6, each of the cuts 38 of the present embodiment has a size LC in the front-rear direction which is half or more of another size LR of the body 36 in the front-rear direction. According to this structure, a size of each of the pressed portions 37 can be made large in the front-rear direction and a spring characteristic of each of the pressed portions 37 can be made high. Moreover, in each of the cuts 38 of the present embodiment, the size LC in the front-rear direction is larger than a size WC in the circumferential direction about the imaginary axis AX (see FIG. 5). According to this structure, a necessary number of the pressed portions 37 can be formed while the spring characteristic of each of the pressed portions 37 is made high. However, the present invention is not limited thereto, but the structure of each of the cuts 38 can be modified as necessary.

The present embodiment can be further variously modified in addition to the already described various modifications. Hereafter, explanation will be made about modifications of the pressed portion 37.

Comparing FIG. 8 with FIG. 6, a cable assembly 10A according to a first modification comprises a connector 20A different from the connector 20 and the cable 70 same as that of the cable assembly 10. The connector 20A has the same structure as that of the connector 20 except that it comprises a contact 30A different from the contact 30. The contact 30A has the same structure as that of the contact 30 except that it has a receiving portion 35A different from the receiving portion 35.

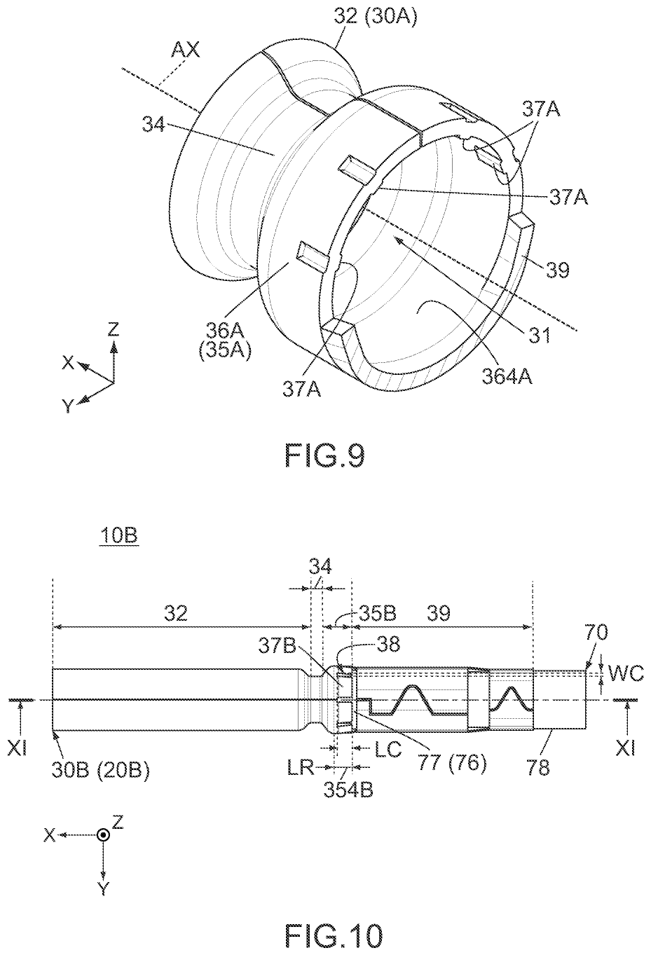

Comparing FIG. 9 with FIG. 5, the receiving portion 35A has a body 36A different from the body 36 and has four pressed portions (projecting portions) 37A instead of the pressed portions 37. The body 36A has an inner surface 364A different from the inner surface 364. The receiving portion 35A has the same structure as that of the receiving portion 35 except for the aforementioned differences.

Referring to FIG. 9, the body 36A has a circular ring shape. The inner surface 364A of the body 36A extends along the front-rear direction in an imaginary cylindrical surface. Each of the pressed portions 37A of the present modification is a projecting portion 37A. Each of the projecting portions 37A projects inward from the inner surface 364A of the receiving portion 35A in the YZ-plane.

Referring to FIGS. 8 and 9, according to the present modification, the outer conductor 76 including the folded portion 77 may be press-fit into the receiving portion 35A. Instead, a part of the body 36A which is formed with the pressed portions 37A may be opened outward in the YZ-plane before the outer conductor 76 is inserted into the receiving portion 35A. In this instance, the open part may be closed after the outer conductor 76 is received in the receiving portion 35. As a result, the outer conductor 76 is pressed against the pressed portions 37A. In any instances, each of the pressed portions 37A is located outward of the outer conductor 76 in the YZ-plane and is pressed against the outer conductor 76 under the connected state. The present modification provides the contact 30A which has stable anti-noise performance.

The pressed portions 37A of the present modification are provided only on an upper part of the inner surface 364A of the body 36A and are arranged in the circumferential direction about the imaginary axis AX with regular intervals. However, the present invention is not limited thereto. For example, the number and the arrangement of the pressed portions 37A can be modified as necessary.

Comparing FIGS. 10, 12 and 13 with FIG. 6, a cable assembly 10B according to a second modification comprises a connector 20B different from the connector 20 and the cable 70 same as that of the cable assembly 10. The connector 20B has the same structure as that of the connector 20 except that it comprises a contact 30B different from the contact 30. The contact 30B has the same structure as that of the contact 30 except that it has a receiving portion 35B different from the receiving portion 35.

Comparing FIG. 14 with FIG. 5, the receiving portion 35B has a rear portion 354B different from the rear portion 354. The rear portion 354B has four pressed portions (spring pieces) 37B instead of the pressed portions 37. The receiving portion 35B has the same structure as that of the receiving portion 35 except for the aforementioned differences.

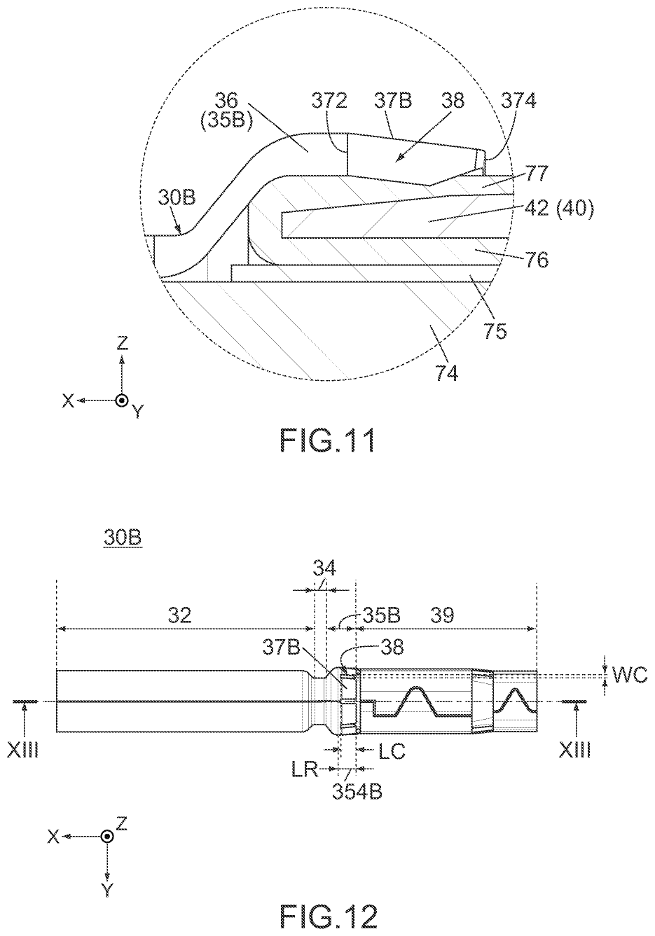

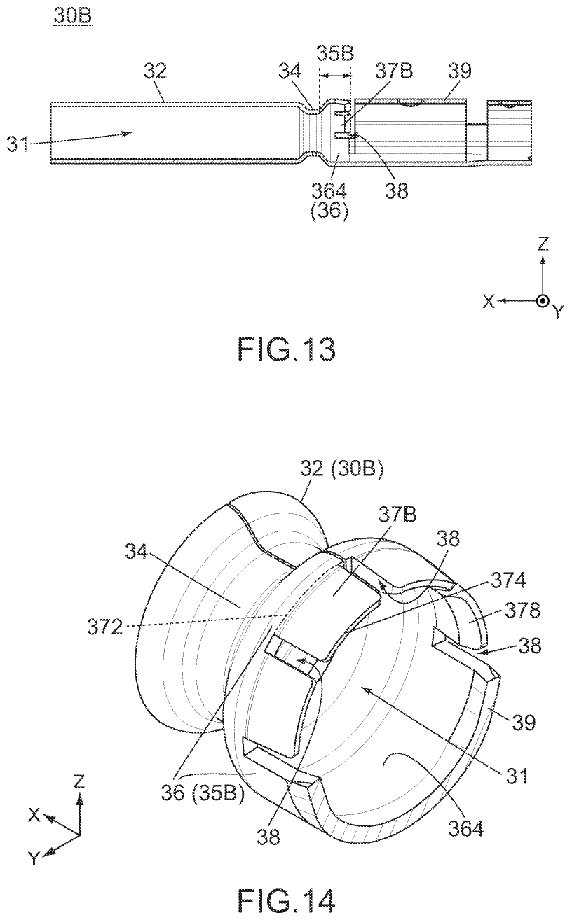

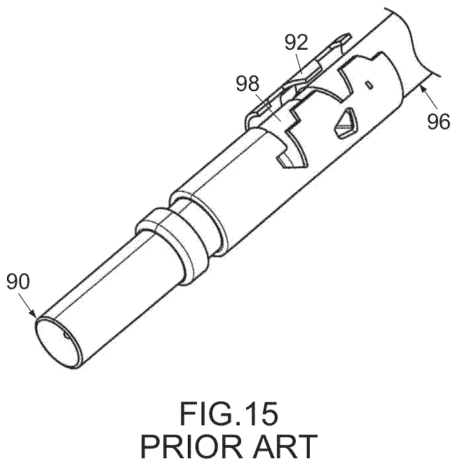

Referring to FIG. 13 together with FIG. 5, each of the pressed portions 37B is a spring piece 37B. Each of the spring pieces 37B has a structure similar to that of the spring piece 37 and is resiliently deformable similarly to the spring piece 37. However, each of the spring pieces 37B is different from the spring piece 37 in that it extends rearward along the front-rear direction while being inclined inward in the YZ-plane under a state where the contact 30B is not connected to the cable 70 (see FIG. 10). Referring to FIG. 11, each of the spring pieces 37B extends rearward along the front-rear direction while being inclined inward in the YZ-plane even under the connected state.

Referring to FIG. 11, when the outer conductor 76 including the folded portion 77 is inserted into the receiving portion 35B, each of the pressed portions 37B is pressed by the outer conductor 76 and is resiliently deformed so that the pressed portions 37B are opened outward in the YZ-plane. As a result, each of the pressed portions 37B is more securely pressed against the outer conductor 76 than the pressed portion 37. Thus, each of the pressed portions 37B is located outward of the outer conductor 76 in the YZ-plane and is pressed against the outer conductor 76 under the connected state. The present modification provides the contact 30B which has stable anti-noise performance.

The receiving portion 35B of the present modification can be modified similarly to the receiving portion 35. Moreover, the aforementioned embodiment can be further variously modified in addition to the already described various modification. For example, referring to FIGS. 5 and 9, the receiving portion 35 may have one or more of the spring pieces 37 and one or more of the projecting portions 37A. In other words, at least one of the pressed portions 37 may be a spring piece, and at least one of the pressed portions 37 may be a projecting portion.

The present application is based on a Japanese patent application of JP2021-119229 filed on Jul. 20, 2021 before the Japan Patent Office, the content of which is incorporated herein by reference.

While there has been described what is believed to be the preferred embodiment of the invention, those skilled in the art will recognize that other and further modifications may be made thereto without departing from the spirit of the invention, and it is intended to claim all such embodiments that fall within the true scope of the invention.

### REFERENCE SIGNS LIST

10, 10A, 10B cable assembly
20, 20A, 20B connector
30, 30A, 30B contact
302 slit
31 passing hole
32 connection portion
34 narrow portion
35, 35A, 35B receiving portion
352 front portion
354, 354B rear portion
36, 36A body
362 ring-like portion
364, 364A inner surface
37, 37B pressed portion (spring piece)
37A pressed portion (projecting portion)
372 front end
374 rear end
378 sloping surface
38 cut
39 crimp portion
392 crimp piece
AX imaginary axis
GP gap
40 conductive member
42 received portion
50 dielectric member
60 inner contact
70 cable
702 front end portion
72 inner conductor
74 inner dielectric
75 conductive coat
76 outer conductor
77 folded portion
78 sheath

1. A contact configured to be connected to a front end portion of a cable in a front-rear direction, the cable having an outer conductor provided on an outer circumference thereof, wherein:
the contact has a crimp portion and a receiving portion;
the crimp portion is crimped on the outer conductor so that it surrounds the outer conductor under a connected state where the contact is connected to the cable;
the receiving portion is located forward of the crimp portion and partially receives the outer conductor under the connected state;
the receiving portion has two or more pressed portions; and
each of the pressed portions is located outward of the outer conductor in a perpendicular plane perpendicular to the front-rear direction and is pressed against the outer conductor under the connected state.

2. The contact as recited in claim 1, wherein:
at least one of the pressed portions is a spring piece; and
the spring piece extends along the front-rear direction and is resiliently deformable with a rear end which is a free end.

3. The contact as recited in claim 2, wherein the spring piece extends along the front-rear direction while being inclined inward in the perpendicular plane.

4. The contact as recited in claim 1, wherein:
at least one of the pressed portions is a projecting portion; and
the projecting portion projects inward from an inner surface of the receiving portion in the perpendicular plane.

5. The contact as recited in claim 1, wherein:
the contact has a narrow portion;
the narrow portion is located forward of the receiving portion; and
the narrow portion has a size in the perpendicular plane which is smaller than another size of the receiving portion in the perpendicular plane.

6. A connector comprising the contact as recited in claim 1 and a conductive member, wherein:
the conductive member has a received portion;
the received portion is located at a front end of the conductive member;
the received portion is narrowed forward; and
under the connected state, the outer conductor is formed with a folded portion which is folded rearward, the conductive member is located inward of the folded portion in the perpendicular plane, the folded portion is sandwiched between the crimp portion and the conductive member, and the received portion of the conductive member is received in the receiving portion of the contact together with the folded portion.

7. A cable assembly comprising the contact as recited in claim 1 and a cable, wherein:
the cable has an outer conductor provided on an outer circumference thereof; and
the contact is connected to a front end portion of the cable.
